(19) United States
(12) Patent Application Publication
(10) Pub. No.: US 2008/0266839 A1
(43) Pub. Date: Oct. 30, 2008

(54) HEADWEAR AND HEADWEAR BILL WITH INTEGRATED LIGHT ASSEMBLY

(76) Inventors: Thomas A. Claypool, Venice, CA (US); Forrest David Monk, Venice, CA (US)

Correspondence Address: Thomas Claypool, 1224 Elm Street, Venice, CA, 90291, US

(21) Appl. No.: 11/740,065

(22) Filed: Apr. 25, 2007

(51) Int. Cl. F21V 21/084

(52) U.S. Cl. 362/106; 2/209.13

(57) ABSTRACT

A lighted hat as disclosed herein includes a light assembly that is integrated into the bill section of the hat. The bill section includes a rigid substrate that has features for accommodating the light assembly. The light assembly includes at least one light element, a power supply for the at least one light element, and a control element that controls activation of the at least one light element. The substrate and the entire light assembly (other than the light-emitting portion of the light element) is covered by the outer material of the bill section. The integrated nature of the light assembly results in a clean and streamlined appearance for the lighted hat.

### TECHNICAL FIELD

Embodiments of the subject matter described herein relate generally to apparel such as headwear. More particularly, embodiments of the subject matter relate to headwear, such as a baseball cap, having an integrated lighting element formed therein.

### BACKGROUND

The prior art is replete with many different headwear designs, including hats, caps, and visors. Headwear that resemble baseball caps are very popular, especially when the caps are adorned with logos, lettering, or designs of interest. Moreover, caps are often combined with additional features or functionality for marketing as novelty items. For example, the prior art includes headwear with integrated beverage can holders, headwear with spinning propellers mounted thereon, headwear with false hair sewn into the fabric, headwear with integrated electric cooling fans, and the like.

One existing hat design includes a lighting module that is attached to the main body portion of the hat (i.e., the portion of the hat that covers the person's head). This hat design utilizes a separate lighting module that is mounted through a hole formed within the main body of the hat. After installation onto the hat, most of the lighting module resides within the hat itself within the space that would normally be above the person's head. This particular type of hat may be difficult to produce and expensive to manufacture due to the separate lighting module. Moreover, the position of the lighting module may result in discomfort to the wearer.

### BRIEF SUMMARY

A piece of headwear (such as a cap) as disclosed herein includes an integrated lighting assembly that is unobtrusive and lightweight. The lighting assembly can be completely implemented into the bill of a cap, which enables illuminated bills to be produced and sold separately from the remainder of the cap. In addition, the lighting assembly can be smoothly integrated into a substrate for the bill of a cap, resulting in a streamlined appearance for the cap that keeps the lighting assembly virtually hidden from view.

The above and other aspects of the invention may be carried out in one embodiment by a lighted hat that includes a cap section, a bill section coupled to the cap section, the bill section having a substrate and an outer material covering the substrate, and a light assembly integrated into the bill section. The light assembly includes a light element, a power supply configured to power the light element, and a control element configured to regulate application of operating power from the power supply to the light element. The outer material of the bill section covers at least the power supply and the control element.

The above and other aspects of the invention may be carried out in another embodiment by a lighted bill for headwear. The lighted bill includes a substrate, an outer material covering the substrate, and a light assembly coupled to the substrate. The light assembly includes a light element, a power supply configured to power the light element, and a control element configured to regulate application of operating power from the power supply to the light element. The outer material covers at least the power supply and the control element.

The above and other aspects of the invention may be carried out in another embodiment by a lighted bill component for headwear. The lighted bill component includes a substrate having a forward edge and a rearward edge, a light cavity formed within the substrate, the light cavity extending from the forward edge toward the rearward edge, a light element positioned within the light cavity, the light element being configured to generate a beam of light from the forward edge when powered, a battery cavity formed within the substrate, the battery cavity being configured to accommodate a battery contact receptacle, and an electronic architecture coupled between the battery contact receptacle and the light element, the electronic architecture being configured to control activation of the light element.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of an embodiment of a lighted hat;

FIG. 2 is a top view of the lighted hat shown in FIG. 1;

FIG. 3 is a top view of an embodiment of a substrate suitable for use with a lighted hat;

FIG. 4 is an edge view of the substrate shown in FIG. 3, as viewed along line A-A in FIG. 3;

FIG. 5 is a perspective view of an embodiment of an electronic subassembly suitable for use with a lighted hat;

FIG. 6 is a top view of the substrate shown in FIG. 3, with an electronic subassembly installed therein;

FIG. 7 is a bottom view of the substrate shown in FIG. 3, with an electronic subassembly installed therein; and

FIG. 8 is a schematic representation of an electronic subassembly suitable for use with a lighted hat.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of headwear and lighting configurations and that the hat described herein is merely one suitable example.

For the sake of brevity, conventional techniques and technologies related to hat manufacturing, electronic circuits, electronic packaging, and other functional aspects of the systems (and the individual operating components of the systems) may not be described in detail herein. Furthermore, the connecting lines shown in FIG. 8 is intended to represent example functional relationships and/or physical couplings between the various elements. It should be noted that many alternative or additional functional relationships or physical connections may be present in an embodiment of the subject matter.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 8 depicts one example arrangement of elements, additional intervening elements, devices, features, or components may be present in an embodiment of the depicted subject matter.

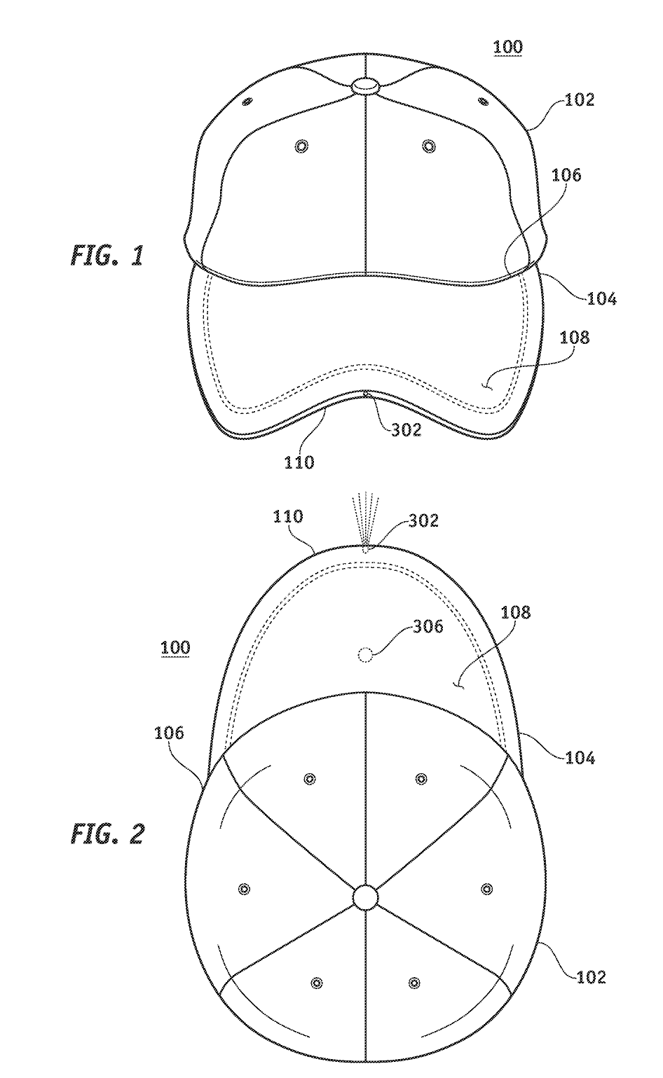

FIG. 1 is a perspective view of an embodiment of a lighted hat 100, and FIG. 2 is a top view of lighted hat 1 00. Lighted hat 100 represents just one possible embodiment of the subject matter described herein. It should be appreciated that the concepts described below are also applicable to other hat designs and configurations. The “baseball cap” version of lighted hat 100 is presented here in a non-limiting manner.

Lighted hat 100 generally includes, without limitation: a cap section 102; a bill section 104 coupled to cap section 102; and a light assembly integrated into bill section 104. Most of the light assembly is hidden from view in FIG. 1 and FIG. 2. Indeed, virtually all of the light assembly is intentionally hidden from view. This feature makes lighted hat 100 appealing to consumers.

Cap section 102 represents the main section of lighted hat 100 that covers the person's head. In practice, cap section 102 may be formed from any suitable material such as, without limitation: wool, cotton, polyester, foam, plastic mesh, fabric, or any combination thereof. Cap section 102 may be fitted for the user or it may be adjustable as is known to those skilled in the art. As shown in FIG. 2, this embodiment of cap section 102 has a generally circular rim 106. Bill section 104 is coupled to the front portion of rim 106; bill section 104 may be coupled to rim 106 using any suitable technique or operation, e.g., sewing or gluing. In preferred embodiments, bill section 104 includes a somewhat rigid and stiff substrate, which is at least partially covered by an outer material 108. This outer material 108 may be formed from any suitable material, including those described above for cap section 102. In practice, outer material 108 surrounds the two primary surfaces of the inner substrate (the top and bottom surfaces), and outer material 108 may be formed around the exposed edges of the substrate. Outer material 108 may be glued or otherwise affixed to the substrate to provide a clean and flush appearance for bill section 104. Moreover, outer material 108 may be sewn to cap section 102 for purposes of coupling bill section 104 to cap section 102.

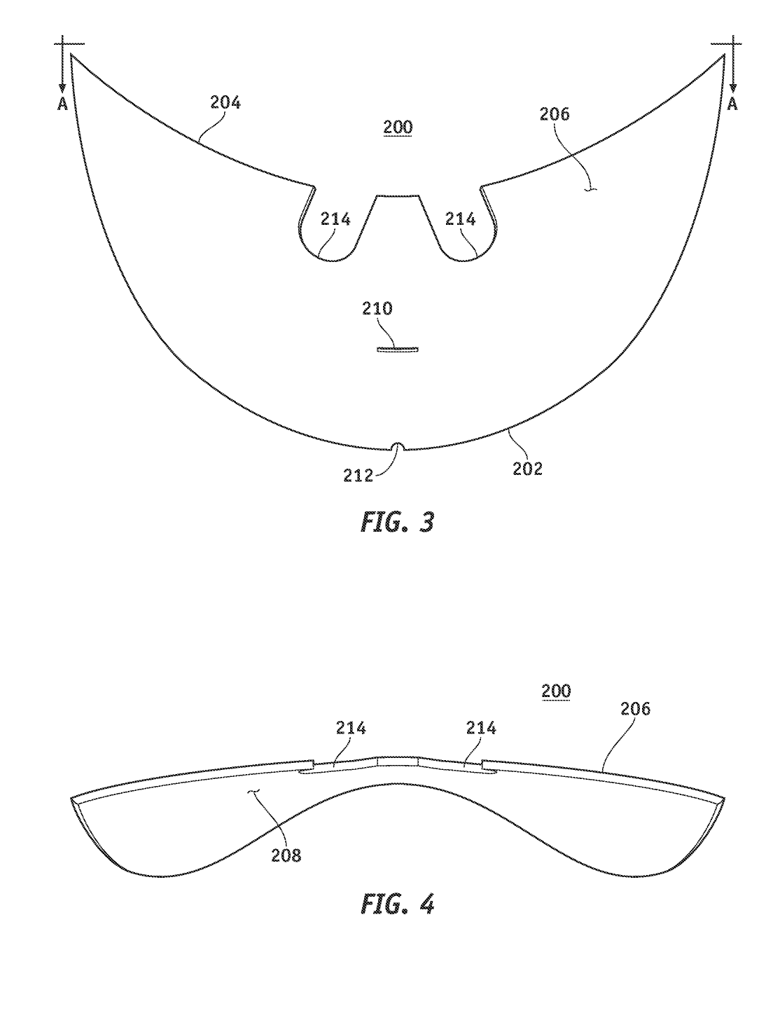

FIG. 3 is a top view of an embodiment of a substrate 200 suitable for use with a lighted hat such as lighted hat 100, and FIG. 4 is an edge view of substrate 200 as viewed along line A-A in FIG. 3. As mentioned above, substrate 200 functions as an internal support element for bill section 104 of lighted hat 100 and, therefore, is hidden from view once lighted hat 100 has been constructed. In practice, substrate 200 may be formed from any suitable material, including, without limitation: a molded plastic; cardboard; wood; metal; or any suitably stiff and rigid composition. In preferred embodiments, substrate 200 is formed from molded plastic. In certain embodiments, substrate 200 is formed from a material that is an electric insulator because substrate 200 contacts electrical components of the light assembly. For a typical baseball cap configuration, substrate 200 has a curved contour as depicted in FIG. 4, which results in the contoured bill section 104 shown in FIG. 1. For a typical baseball cap configuration, substrate 200 may have a thickness between 3 to 4 millimeters.

This embodiment of substrate 200 includes, without limitation: a forward edge 202; a rearward edge 204 opposite forward edge 202; a top surface 206; a bottom surface 208; a hole 210 that extends from the top surface 206 to the bottom surface 208; a cavity 212 that extends from the forward edge 202 toward the rearward edge 204; and two cavities 214 that extend from the rearward edge 204 toward the forward edge 202. Forward edge 202 corresponds to the forward edge 110 of bill section 104 (see FIG. 1), and rearward edge 204 corresponds to the portion of bill section 104 that is near cap section 102.

Hole 210 is shaped like a rectangular slot in this example, however, the rectangular shape is not a requirement. For this embodiment, hole 210 is located near the center of substrate 200, between forward edge 202 and rearward edge 204. Hole 210 is suitably sized, shaped, and located to accommodate conductive leads that are utilized by one or more light elements of lighted hat 100 (described in more detail below). In alternate embodiments, more than one hole 210 may be formed in substrate 200 to accommodate the desired routing of the conductive leads and the desired number and location of light elements. Other embodiments need not employ hole 210. For example, it may be possible to surface-mount the conductive leads or it may be possible to route the conductive leads in channels formed in top surface 206 or bottom surface 208.

As depicted in FIG. 3, cavity 212 may be realized as a U-shaped cutout formed in forward edge 202 of substrate 200. Alternatively, cavity 212 may be realized as a depression formed in top surface 206 or bottom surface 208 of substrate 200 (in other words, cavity 212 need not go completely through substrate 200). For this embodiment, cavity 212 is located near the peak of substrate 200, i.e., at the center of forward edge 202. Cavity 212 is suitably sized, shaped, and located to accommodate one or more light elements for lighted hat 100. For example, cavity 212 may be sized and shaped to receive a single three millimeter sized LED light element. In the preferred implementation, cavity 212 and the LED light element are cooperatively shaped and sized such that the LED light element does not protrude (or only slightly protrudes) above top surface 206 or below bottom surface 208. In this regard, cavity 212 may be referred to herein as a “light cavity.” Of course, more than one cavity 212 may be formed in substrate 200 to accommodate the desired number of light elements.

As depicted in FIG. 3, each of the cavities 214 may be realized as a U-shaped cutout formed in rearward edge 204 of substrate 200. Alternatively, a cavity 214 may be realized as a depression formed in top surface 206 or bottom surface 208 of substrate 200 (in other words, a cavity 214 need not go completely through substrate 200). For this embodiment, the cavities 214 are located near the center of rearward edge 204. Each cavity 214 is suitably sized, shaped, and located to accommodate a battery contact receptacle, which in turn receives a battery for lighted hat 100. In the preferred implementation, each cavity 214 and the battery contact receptacles are cooperatively shaped and sized such that the battery contact receptacles do not protrude (or only slightly protrude) above top surface 206 or below bottom surface 208. In this regard, cavities 214 may be referred to herein as “battery cavities.” In one practical embodiment, each cavity 214 is sized and shaped to accommodate a 3-volt disc shaped battery, such as a standard CR clock battery. Of course, only one cavity 214 or more than two cavities 214 may be formed in substrate 200 to accommodate the desired number of batteries.

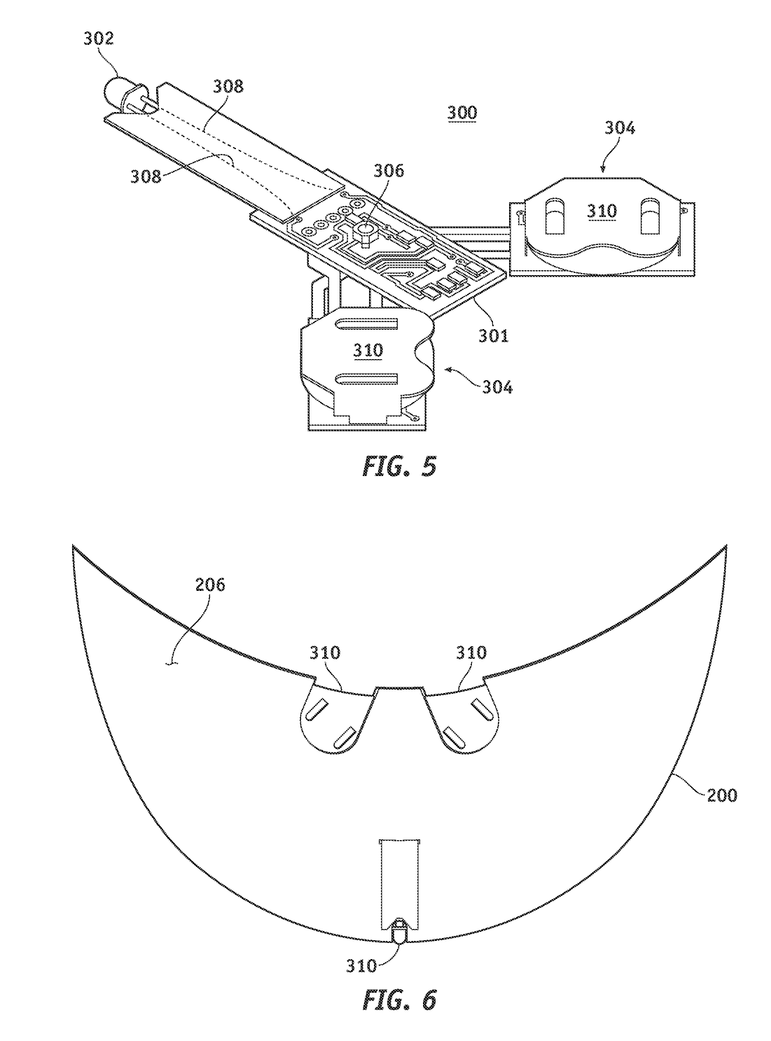

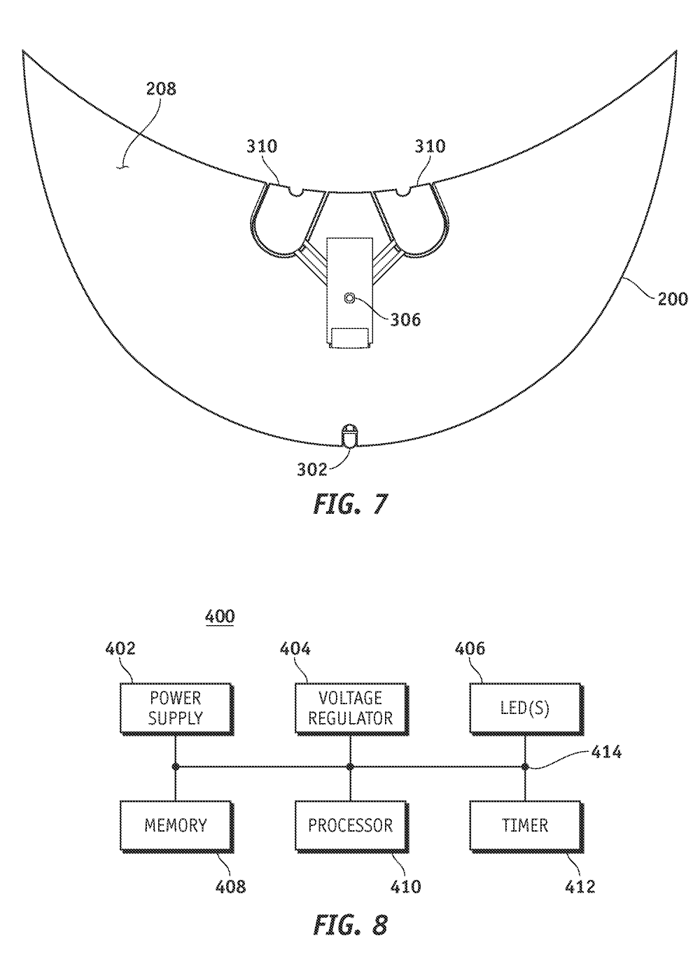

FIG. 5 is a perspective view of an embodiment of an electronic subassembly 300 suitable for use with lighted hat 100, FIG. 6 is a top view of substrate 200 with electronic subassembly 300 installed therein, and FIG. 7 is a bottom view of substrate 200 with electronic subassembly 300 installed therein. Electronic subassembly 300 represents one possible implementation of a light assembly for an embodiment of a lighted hat as described herein. In practice, electronic subassembly 300 may be realized in various different forms, depending upon the intended hat design, the desired lighting configuration, the desired operating features, and the like.

Referring to FIG. 6 and FIG. 7, electronic subassembly 300 is suitably configured such that it can be integrated into substrate 200 and, therefore, integrated into bill section 104. As shown in FIG. 1, lighted hat 100 is preferably configured such that electronic subassembly 300 is completely integrated with bill section 104. Indeed, substrate 200 or bill section 104 can be manufactured separately with the integrated electronic subassembly 300 and sold to hat manufacturers for final assembly. For ease of manufacturing and design, and to achieve a balanced hat, electronic subassembly 300 is located symmetrically within bill section 104, as depicted in FIG. 6 and FIG. 7.

This embodiment of electronic subassembly 300 includes, without limitation: a circuit board 301; a light element 302; a power supply 304 configured to power light element 302; a control element 306 configured to regulate application of operating power from power supply 304 to light element 302; and conductive leads 308 coupled between circuit board 301 and light element 302. In this example, power supply 304 is realized as two batteries, which are housed in respective battery contact receptacles 3 10.

Circuit board 301 may include any number of electronic components and conductive traces arranged as needed for the intended functionality of electronic subassembly 300. For example, circuit board 301 may include a memory element, a processor, an automatic timer, resistors, capacitors, or the like. Once installed onto substrate 200, circuit board 301 is located proximate the rearward edge 204 of substrate (see FIG. 7). Circuit board 301 is preferably formed as a flat and thin package (which may be flexible or pliable to form to the contour of substrate 200. The light element 302 is located proximate the forward edge 202 of substrate 200. This location is desirable so that light element 302 can serve as a hands-free flashlight for the user. Accordingly, conductive leads 308 can be routed from circuit board 301, through hole 210, and toward forward edge 110 as depicted in FIG. 6 and FIG. 7. In particular, conductive leads 308 are routed through hole 210 and above the top surface 206 of substrate 200, as shown in FIG. 6. Conductive leads 308 may be implemented with a flexible flat ribbon lead that can be affixed to the substrate 200. The flexible nature of the ribbon lead allows it to be flush with substrate 200.

Light element 302 may be, without limitation: an LED element (any color, such as red, white, blue, or ultraviolet); a halogen bulb; or the like. Light element 302 is preferably sized such that at least a portion of it resides within cavity 212. In one embodiment, light element 302 is sized such that it can be nested in cavity 212 and such that its thickness is not greater than the thickness of substrate 200. Light element 302 can be located and aligned such that it generates a beam of light from the forward edge 110 of bill section 104 (when powered). This projection of light is illustrated in FIG. 2. In certain embodiments, light element 302 is located such that it does not protrude beyond the forward edge 110 of bill section 104.

Light element 302 obtains its operating voltage from power supply 304. As mentioned previously, power supply 304 may include batteries located within battery contact receptacles 3 10. The batteries may be non-rechargeable and disposable batteries having a relatively long lifespan that contemplates the useful life of lighted hat 100. Electronic subassembly 300 is suitably configured to regulate operating power provided by the batteries to light element 302 using, for example, control element 306, switches, timers, or the like. In this regard, control element 306 may be realized as a button switch, where actuation of the switch turns the light on or off. In one embodiment, light element 302 remains powered on until control element 306 switches it off. In another embodiment, light element 302 remains powered on for a designated period of time (controlled by an automatic timer in electronic subassembly 300), after which operating voltage is removed from light element 302. In other words, the automatic timer is suitably configured to initiate removal of operating power from light element 302 after it has been continuously powered for a threshold period of time. This automatic shutoff feature is desirable in embodiments where the batteries are permanently installed.

As mentioned above, electronic subassembly 300 can be sized, shaped, and configured such that it can be easily covered by the outer material 108 of bill section 104. In this regard, outer material 108 should cover at least the power supply 304 and the control element 306. Moreover, the thickness of battery contact receptacles should be no greater than the thickness of substrate 200 at the location of cavities 214. The button switch version of control element 306 can be located such that it is accessible under bill section 104 (see FIG. 2 and FIG. 7). To achieve a clean and streamlined appearance, electronic subassembly 300 is configured to follow contours of substrate 200. In this embodiment, electronic subassembly 300 employs low profile and flat components (see FIG. 5), a flexible ribbon lead that carries conductive leads 308, and a circuit board 301 that utilizes very small surface-mounted components. Moreover, the connection between battery contact receptacles 310 and circuit board 301 are thin and flexible. Electronic subassembly 300 can then be coupled to substrate 200 using, for example, adhesive before substrate 200 is enclosed by outer material 108. Outer material 108 may include one or more holes or eyelets formed therein for light element 302. Alternatively, outer material 108 may include a small “window” or section that is transparent, translucent, or otherwise able to transmit at least some of the light generated by light element 302.

FIG. 8 is a schematic representation of an electronic subassembly 400 suitable for use with a lighted hat, such as lighted hat 100. Electronic subassembly 400 includes, without limitation: a power supply 402; a voltage regulator 404; one or more LEDs 406 that serve as light elements; a suitable amount of memory 408; a processor 410; and a timer 412. These elements may be coupled together using a bus 414 or any appropriate interconnection architecture.

Power supply 402 is configured as described above. In practice, power supply 402 may be realized with one or more batteries. Voltage regulator 404 may be necessary to convert the battery voltage into the operating voltage of LEDs 406. Alternatively, voltage regulator 404 may be utilized in some embodiments to provide a variable illumination intensity for the light elements. LEDs 406 may be configured as described above to generate light beams as desired. Memory 408 may be utilized to store automatic shutoff time thresholds, light patterns, or any other information for electronic subassembly 400. In this regard, memory 408 may include an appropriate amount of flash-based memory that is pre-programmed before assembly of the lighted hat.

Processor 410 can be suitably configured to carry out the functions and operations described herein for the electronic subassemblies. Processor 410 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

Timer 412 operates as described above to control the automatic shutoff feature. Timer 412 may be pre-programmed with a certain time threshold, such as five minutes. If the LEDs 406 have remained on continuously for more than the time threshold, then timer 412 switches the power supply 402 off, thus turning the LEDs 406 off to save power.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A lighted hat comprising:
a cap section;
a bill section coupled to the cap section, the bill section having a substrate and an outer material covering the substrate; and
a light assembly integrated into the bill section, the light assembly having a light element, a power supply configured to power the light element, and a control element configured to regulate application of operating power from the power supply to the light element; wherein
the outer material of the bill section covers at least the power supply and the control element.

2. A lighted hat according to claim 1, wherein the light assembly is completely integrated with the bill section.

3. A lighted hat according to claim 1, wherein the substrate is formed from a material that is an electric insulator.

4. A lighted hat according to claim 1, wherein:
the substrate has a forward edge and a rearward edge;
the light assembly further comprises a circuit board located proximate the rearward edge, and conductive leads coupled between the circuit board and the light element; and
the light element is located proximate the forward edge.

5. A lighted hat according to claim 4, wherein:
the substrate comprises a top surface, a bottom surface, and a hole extending from the top surface to the bottom surface, the hole being located between the forward edge and the rearward edge; and
the conductive leads are routed from the circuit board, through the hole, and toward the forward edge.

6. A lighted hat according to claim 5, wherein the conductive leads are routed from the circuit board, through the hole, and above the top surface of the substrate toward the forward edge.

7. A lighted hat according to claim 1, further comprising an automatic timer coupled to the control element, the automatic timer being configured to initiate removal of operating power from the light element after the light element has been continuously powered for a threshold period of time.

8. A lighted hat according to claim 1, wherein the power supply comprises at least one non-rechargeable battery that is enclosed by the outer material of the bill section.

9. A lighted hat according to claim 1, wherein:
the bill section has a forward edge; and
the light element is configured to generate a beam of light from the forward edge.

10. A lighted hat according to claim 1, wherein:
the substrate includes a forward edge, a rearward edge, and a cavity extending from the forward edge and toward the rearward edge; and
the light element resides within the cavity.

11. A lighted bill for headwear, the lighted bill comprising:
a substrate;
an outer material covering the substrate; and
a light assembly coupled to the substrate, the light assembly having a light element, a power supply configured to power the light element, and a control element configured to regulate application of operating power from the power supply to the light element; wherein
the outer material covers at least the power supply and the control element.

12. A lighted bill according to claim 11, wherein the light assembly is configured to follow contours of the substrate.

13. A lighted bill according to claim 11, wherein:
the substrate has a forward edge and a rearward edge;
the light assembly further comprises a circuit board located proximate the rearward edge, and conductive leads coupled between the circuit board and the light element; and
the light element is located proximate the forward edge.

14. A lighted bill according to claim 11, further comprising an automatic timer coupled to the control element, the automatic timer being configured to initiate removal of operating power from the light element after the light element has been continuously powered for a threshold period of time.

15. A lighted bill according to claim 11, wherein the power supply comprises at least one non-rechargeable battery that is enclosed by the outer material.

16. A lighted bill according to claim 11, wherein:
the substrate includes a forward edge, a rearward edge, and a cavity extending from the forward edge and toward the rearward edge; and
the light element resides within the cavity.

17. A lighted bill component for headwear, the lighted bill component comprising:
a substrate having a forward edge and a rearward edge;
a light cavity formed within the substrate, the light cavity extending from the forward edge toward the rearward edge;
a light element positioned within the light cavity, the light element being configured to generate a beam of light from the forward edge when powered;
a battery cavity formed within the substrate, the battery cavity being configured to accommodate a battery contact receptacle; and
an electronic architecture coupled between the battery contact receptacle and the light element, the electronic architecture being configured to control activation of the light element.

18. A lighted bill component according to claim 17, wherein the electronic architecture comprises a circuit board located proximate the rearward edge, and conductive leads coupled between the circuit board and the light element.

19. A lighted bill component according to claim 17, further comprising a battery located within the battery contact receptacle, the battery being configured to provide operating power to the light element.

20. A lighted bill component according to claim 19, wherein the electronic architecture comprises means for regulating operating power provided by the battery to the light element.
